(19) United States
(12) Patent Application Publication
(10) Pub. No.: US 2025/0216499 A1
(43) Pub. Date: Jul. 3, 2025

(54) ACCESS POINT AUTO-LOCATION USING ULTRA-WIDEBAND

(71) Applicant: Cisco Technology, Inc., San Jose, CA (US)

(72) Inventors: Sivadeep Reddy Kalavakuru, Akron, OH (US); Robert Badea, Broadview Heights, OH (US); Ardalan Alizadeh, Milpitas, CA (US); Matthew A. Silverman, Shaker Heights, OH (US)

(73) Assignee: Cisco Technology, Inc., San Jose, CA (US)

(21) Appl. No.: 18/954,044

(22) Filed: Nov. 20, 2024

Related U.S. Application Data
(60) Provisional application No. 63/615,251, filed on Dec. 27, 2023.

(51) Int. Cl. G01S 5/02

(52) U.S. Cl. CPC G01S 5/0289; G01S 5/0205

(57) ABSTRACT

Access Point (AP) location techniques using Ultra-Wideband (UWB) and, specifically, optimizing UWB location techniques to reduce collisions may be provided. AP location techniques using UWB can include determining a plurality of Access Point (AP) pairs. A schedule is determined for the plurality of AP pairs to perform AP-to-AP ranging, preamble codes are determined for each AP pair to manage cross-correlation between AP pairs of the plurality of AP pairs scheduled to perform AP-to-AP ranging simultaneously, wherein the plurality of AP pairs are operable to perform AP-to-AP ranging using Ultra-Wideband (UWB) and according to the schedule and the preamble codes for each AP pair.

### RELATED APPLICATION

Under provisions of 35 U.S.C. § 119 (e), Applicant claims the benefit of and priority to U.S. Provisional Application No. 63/615,251, filed Dec. 27, 2023, the disclosure of which is incorporated herein by reference in its entirety.

### TECHNICAL FIELD

The present disclosure relates generally to providing Access Point (AP) location techniques using Ultra-Wideband (UWB) and specifically to optimizing UWB location techniques to reduce collisions.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Access Point (AP) location techniques using Ultra-Wideband (UWB) in accordance with aspects of the present disclosure.

FIG. 2 is a graph of preamble code cross-correlation for AP location techniques using UWB in accordance with aspects of the present disclosure.

FIG. 3 is a block diagram of an example building where AP location techniques using UWB are implemented in accordance with aspects of the present disclosure.

FIG. 4 is a block diagram of scheduling graphs for AP location techniques using UWB in accordance with aspects of the present disclosure.

FIG. 5 is a flow chart of a method for AP location techniques using UWB in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### Overview

Access Point (AP) location techniques using Ultra-Wideband (UWB) and, specifically, optimizing UWB location techniques to reduce collisions may be provided. AP location techniques using UWB can include determining a plurality of Access Point (AP) pairs. A schedule is determined for the plurality of AP pairs to perform AP-to-AP ranging, preamble codes are determined for each AP pair to manage cross-correlation between AP pairs of the plurality of AP pairs scheduled to perform AP-to-AP ranging simultaneously, wherein the plurality of AP pairs are operable to perform AP-to-AP ranging using Ultra-Wideband (UWB) and according to the schedule and the preamble codes for each AP pair.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Ultra-Wideband (UWB) location techniques, such as the techniques defined in the Institute of Electrical and Electronics Engineers (IEEE) 802.15.4a and 802.15.4z standard, can enable ranging and the location determination of clients with high accuracy compared to other location determination techniques such as Fine Timing Measurement (FTM). UWB location services can estimate the location of client within ten centimeters of the client's actual location in Line-of-Sight (LoS) scenarios and within fifty centimeters in Non-LoS (NLoS) scenarios. Client ranging is based on Time-of-Flight (ToF) measurements, and the ToF measurements can be determined via Two Way Ranging (TWR) or Time Difference of Arrival (TDoA). Using TDoA for a client location determination can require at least four anchors (e.g., Access Points (APs) to perform ranging to achieve an accurate location estimation (e.g., within ten centimeters). Additionally, the accuracy of the location estimation using TDoA or TWR degrades if the client is outside the service area of the anchors or NLoS.

Generally, APs are manually positioned in maps that represent the physical location of the APs, and the maps are used for location techniques. Manually determining the position of APs in the environment and placing the APs in the maps can be tedious and prone to errors, however. Furthermore, AP placement is a consideration in enabling AP-to-AP location services using UWB because the link budget for UWB connections is lower than other connections (e.g., Equivalent Isotropic Radiated Power (EIRP) of −14 Decibel-Milliwatts (dBm)). In some implementations for example, UWB connections have an average range of fifty-five feet. Further, APs may be positioned in a dense arrangement in a typical deployment, such as in a building. The dense arrangement of APs can lead to level of collisions that degrade network performance to unacceptable levels and cause high position failures.

AP auto-location comprises the self-location of APs to enable ranging orchestration for client tracking. APs can therefore be automatically located and positioned on digital floor plans for client tracking, reducing deployment time and eliminating the complexity of manual mapping. Networks may need to provide accurate location services for clients at high speeds (e.g., near real-time) to support client operations such as asset tracking and control (e.g., stadiums, automated robots in warehouses, etc.). Therefore, accurate AP auto-location is required to support location services.

UWB location techniques may be optimized or otherwise improved to lower collisions between APs and increase the isolation of the APs in a dense deployment environment, such as building. APs may be isolated according to sections of an environment, such as on each floor of a building. The UWB location technique improvements can include implementing a scheduler for scheduling initiator and responder sessions between APs for AP auto-location.

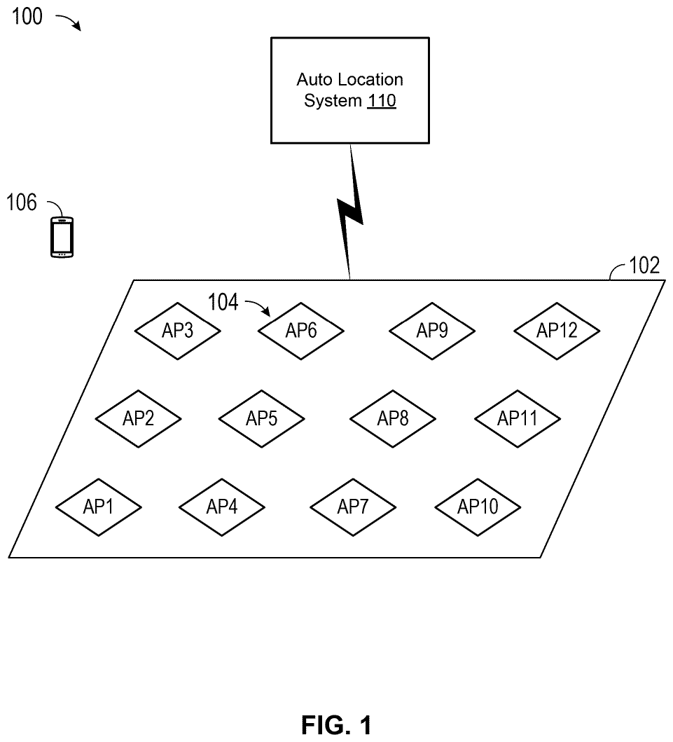

FIG. 1 is a block diagram of an operating environment 100 for AP location techniques using UWB. The operating environment 100 includes a coverage area 102 with APs 104 (e.g., AP1, AP2, AP3, AP4, AP5, AP6, AP7, AP8, AP9, AP10, AP11, AP12, etc.). The coverage area 102 can be any area in which a wireless network is deployed, such as a building, an arena, a campus, and/or the like. The APs 104 may enable devices to access the wireless network, such as by creating a Wireless Local Area Network (WLAN).

The operating environment 100 also includes a client 106 and an auto location system 110. The client 106 and/or the auto location system 110 can be in the coverage area 102 in certain embodiments. The client 106 can be any device that connects to the wireless network via the APs 104, such as a smart phone, a tablet, a personal computer, a server, an Internet-of-Things device, and the like. The auto location system 110 can be a remote system, such as a remote server, and/or a local system, such as a server located in the coverage area 102, a controller (e.g., a WLAN controller), part of the APs 104, and/or the like. The auto location system 110 is configured to enable the APs to perform auto location techniques using UWB and provide location services for the client 106 and other devices connected to the wireless network.

The APs 104 may have one or more UWB radios for communicating with other devices, including each other. The APs 104 may use UWB radios to perform AP to AP ranging sessions (e.g., between two APs 104 such as AP1 and AP2) and other location techniques to leverage the high accuracy capabilities of UWB radios. UWB sessions typically occur over certain channels (e.g., channel 9). For example, the UWB sessions of the APs may occur over a channel with a five Megahertz (MHz) bandwidth. Because multiple UWB sessions can occur at the same time, collisions and interference can occur. Thus, improvements to UWB sessions, such as for location techniques, are directed to isolating the APs and lowering the potential interference that can occur during UWB sessions.

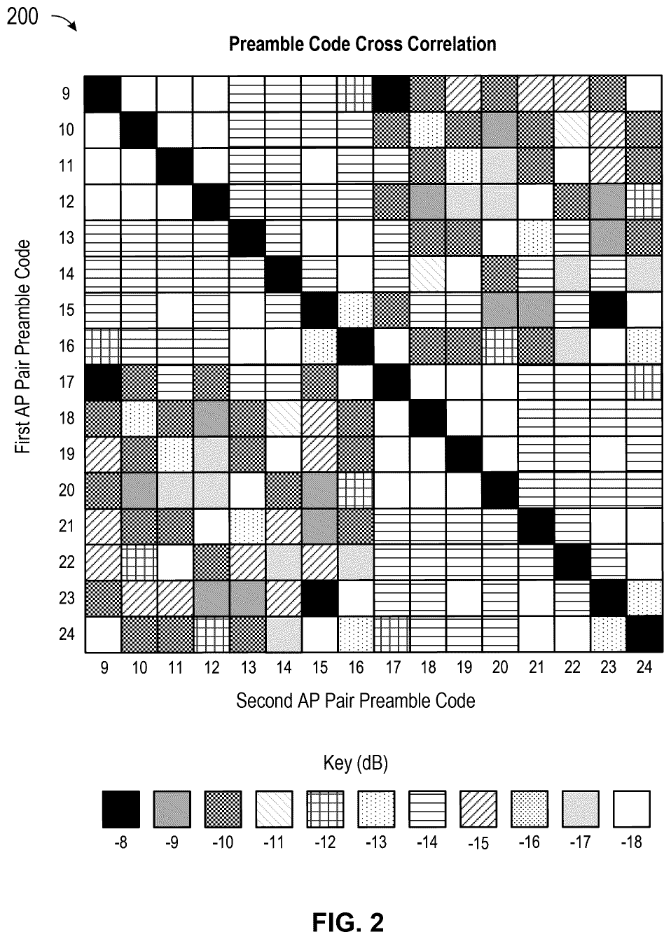

AP to AP ranging can require the precise scheduling of an initiator and responder session between two APs. Furthermore, multiple AP to AP ranging sessions may need to be scheduled simultaneously for AP dense environments, such as the coverage area 102 for example. The auto location system 110 may schedule AP to AP ranging sessions using UWB for AP auto location by improving the isolation of multiple AP pairs performing ranging that are close together (e.g., close enough that the APs could interfere with each other). The auto location system 110 can improve AP pair isolation using preamble codes with low cross-correlation, as will be described in further detail herein with respect to FIG. 2.

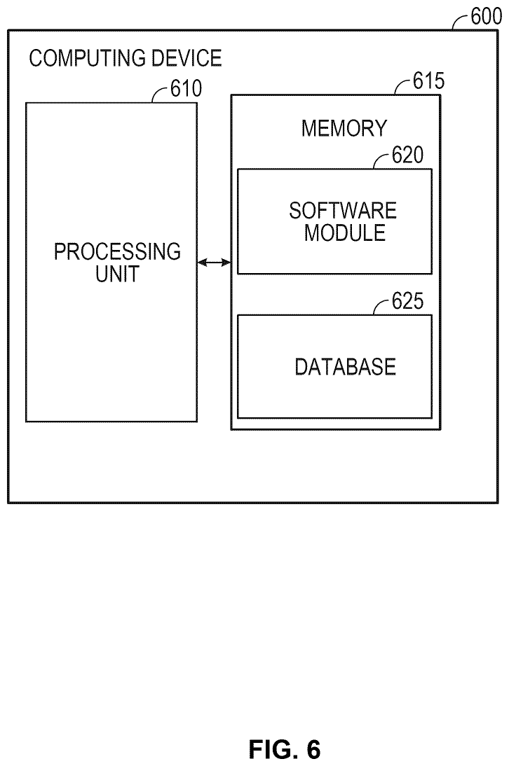

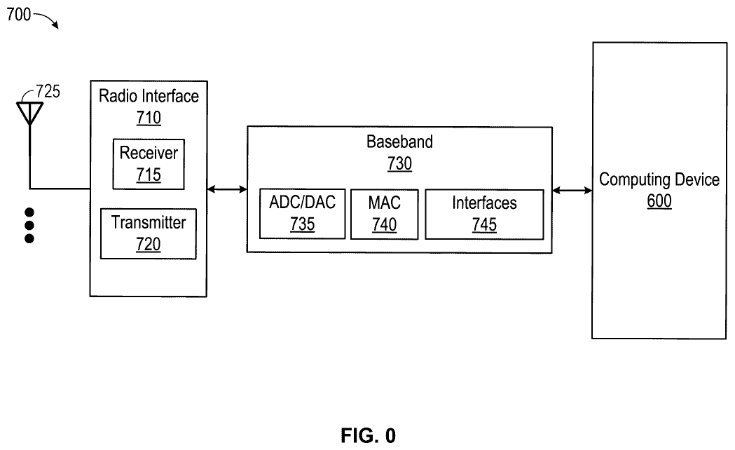

The elements described above of the operating environment 100 (e.g., the APs 104, the client 106, the auto location system 110, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

A preamble code is a configurable parameter in a UWB communication link for identifying subchannels, located in the Synchronization (SYNC) field of a UWB frame (e.g., a PHY Protocol Data Unit (PPDU). Particularly, the preamble code is a sequence of pulses that constitute the SYNC field. The preamble code can identify both UWB Base Pulse Repetition Frequency (BPRF) and Higher Pulse Repetition Frequency (HPRF) Physical Layer (PHY) Channels. The Hight Rate Pulse (HRP) UWB PHY supports two lengths of preamble code, a ninety-one symbol code for HPRF and an optional one-hundred and twenty-seven symbol code for BPRF, and the preamble code is a sequence of symbols drawn from a ternary alphabet (−1, 0, 1) and selected for use in the HRP UWB PHY because of their periodic autocorrelation properties.

FIG. 2 is a graph 200 of preamble code cross-correlation for AP location techniques using UWB. Preamble codes are designed to have low cross-correlation with each other with the intention that separate channels with different preamble codes can be used simultaneously without devices interfering with each other. Accordingly, the auto location system 110 can use preamble coding to improve AP isolation. In certain embodiments, the auto location system 110 determines preamble codes that result in a low cross-correlation between the AP pairs when they're operating simultaneously (e.g., lowest possible, sufficient to prevent or reduce interference to a level the APs and other devices can operate correctly, etc.), thereby improving isolation of the AP pairs. The auto location system 110 can assign or otherwise send the preamble codes to the AP pairs so the AP pairs can determine which subchannel to use when communicating. By communicating via the assigned subchannels, the AP pairs may communicate simultaneously without interference or other otherwise with an acceptable level of interference.

The graph 200 illustrates the level of cross-correlation between AP pairs when different preamble codes are used. The x-axis of the graph 200 is the second AP pair preamble code, and the y-axis of the graph 200 is the first AP pair preamble code. The first AP pair and the second AP pair may be close enough to cause interference if not using the subchannel indicated by the assigned preamble code. The key illustrates the level of cross-correlation between the first AP pair and the second AP pair for different preamble code combinations. For example, the first AP pair having a preamble code 9 and the second AP pair having a preamble code 9 will result in a strong or high cross-correlation of −8 decibels (dB) as shown in the graph 200. The first AP pair having a preamble code 9 and the second AP pair having a preamble code 10, 11, 12, or 24 will result in a weak or low cross-correlation of −18 dB as shown in the graph 200. The auto location system 110 may compare the expected cross-correlation between AP pairs to a threshold to determine whether the cross-correlation is weak enough in some embodiments. The auto location system 110 can store or otherwise utilize the information illustrated by the graph 200 to determine which combination of preamble codes to use for lowering cross-correlation between AP pairs. The graph 200 includes example data, and the cross-correlation between combinations of preamble codes may vary in other embodiments.

The auto location system 110 can schedule multiple AP-to-AP ranging sessions with preamble codes for adjacent AP-to-AP pairs that have a low cross-correlation, for example using the information of the graph 200. In certain embodiments, there is about 20 dB of isolation between same pulses operating simultaneously in a channel with different preamble code indices and different ternary codes, leading to low or weak cross-correlation. When APs are in a BPRF mode, the auto location system 110 may use a combination of preamble codes 9, 10, 11, 12. For example, the first AP pair can be assigned preamble code 9, and the second AP pair can be assigned preamble code 10, 11, or 12 so there is weak cross-correlation as illustrated by the graph 200 indicating the pairs of preamble codes will have a −18 dB cross-correlation. If the frames of the first AP pair and the second AP pair collide or otherwise cause interference, the auto location system 110 can change the preamble code of one or more of the AP pairs (e.g., isolate or otherwise attenuate AP pairs by about 18 dB to the correct SYNC field).

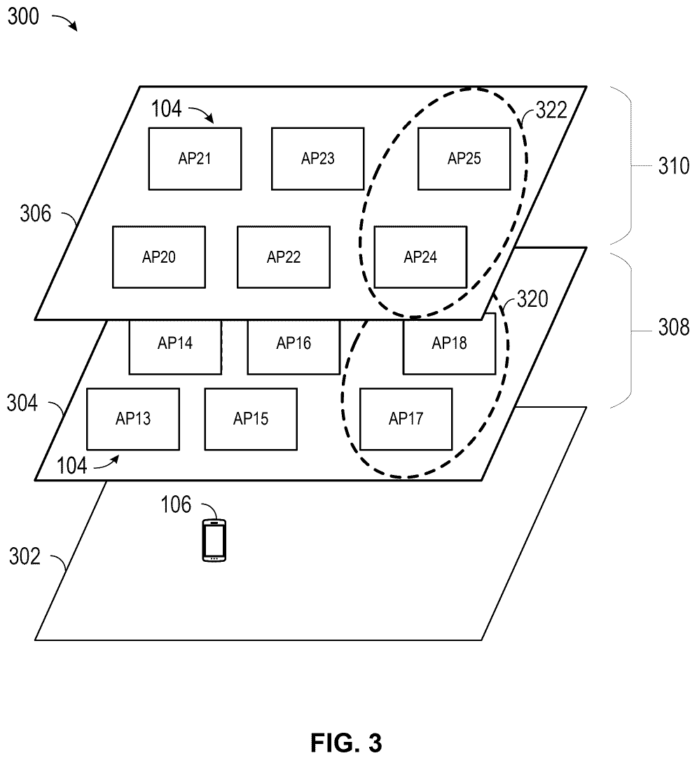

FIG. 3 is a block diagram of an example building 300 where AP location techniques using UWB are implemented. The building 300 may include a floor 302, a floor-ceiling assembly 304, and a roof 306. The building 300 therefore includes a first floor 308 defined by the floor 302 and the floor-ceiling assembly 304 and a second floor 310 defined by the floor-ceiling assembly 304 and the roof 306. The building 300 further includes APs 104 for the first floor 308 (e.g., AP 13, AP14, AP15, AP16, AP17, AP18) and the second floor 310 (e.g., AP20, AP21, AP22, AP23, AP24, AP25). The APs may be mounted to the ceiling portion of the floor-ceiling assembly 304 and the roof 306. The client 106 may be present in the building 300 and communicate with the APs for location services and other network services.

The APs 104 may be close enough to have overlapping ranges and can cause interference. Thus, the auto location system 110 can assign preamble codes for the APs 104 to communicate on different subchannels. For example, AP17 and AP18 may be a first pair of APs 320, and AP24 and AP25 may be a second pair of APs 322. The auto location system 110 can schedule the first pair of APs 320 to communicate according to a preamble code and the second pair of APs 322 to communicate according to another preamble code. Thus, there may be weak cross-correlation of the signals of the first pair of APs 320 and the second pair of APs 322. The auto location system 110 can schedule sessions for AP pairs above and below on neighboring floors with a preamble code that has weak cross-correlation with the adjacent pairs. The auto location system 110 can also schedule sessions for other AP pairs that are close enough to need the scheduling to avoid interference.

In some embodiments, the auto location system 110 will maximize a function of the path loss for adjacent AP pairs and pairs on neighboring floors and cause the APs 104 attenuate the signal strengths based on the maximized function when performing AP-to-AP ranging while keeping in mind of already lower Power Spectral Density (PSD) for UWB (e.g., −41.25 dBm/MHz). For example, the auto location system 110 may determine the lowest signal strength an AP pair can use to effectively communicate for ranging and instruct the AP pair to use the determined signal strength. Thus, the auto location system 110 can control the signal strengths of the APs 104 and the subchannels the APs 104 use when performing ranging to manage potential interference.

To determine the relative location of each AP 104 for scheduling the AP-to-AP ranging sessions, the auto location system 110 can generate a map that represents the locations of the APs 104 or access a map another device created. The auto location system 110 and/or other devices can use discovery protocols, control protocols, pressure sensors, the switch the AP 104 uses, and/or the like to determine the locations of APs 104 when generating the map. In some embodiments for example, APs 104 with UWB anchors are already mapped to each floor of the building 300, so the auto location system 110 can use the anchors to determine locations of each AP 104.

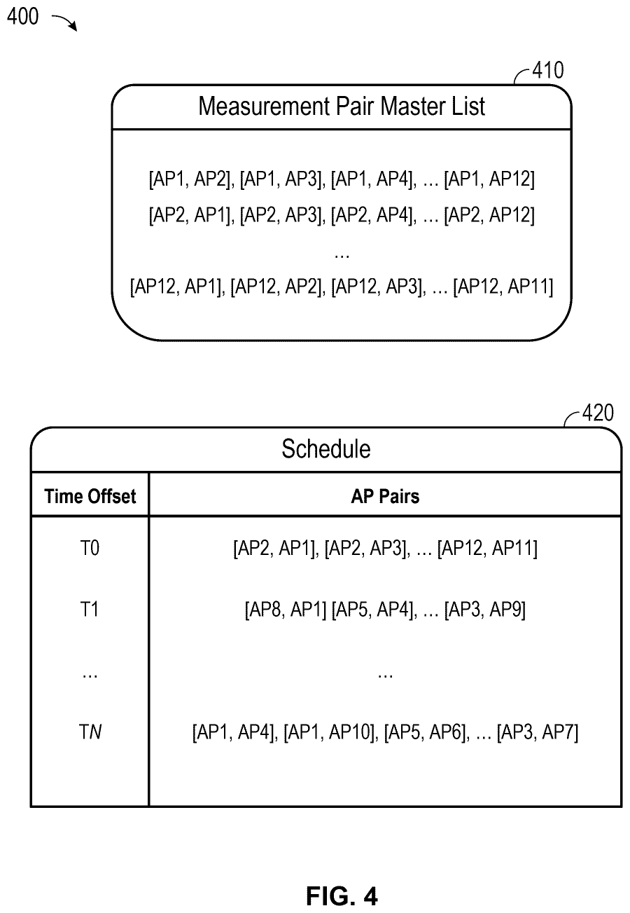

FIG. 4 is a block diagram of scheduling graphs 400 for AP location techniques using UWB in accordance with aspects of the present disclosure. The scheduling graphs 400 include a measurement pair master list 410 and a schedule graph 420. The measurement pair master list 410 includes each AP pair that needs to perform AP-to-AP ranging. The auto location system 110 can determine which AP pairs need to perform ranging based on the locations of the APs 104.

The schedule graph 420 illustrates the schedule the auto location system 110 determines for AP pairs to perform ranging. For example, the auto location system 110 determines AP pairs to communicate at a first time “TO” and the associated preamble codes for the pairs, AP pairs to communicate at a second time “T1” and the associated preamble codes for the pairs, and so on for however many periods of time are necessary for AP-to-AP ranging.

In certain embodiments, the auto location system 110 can schedule the AP ranging sessions based on a session priority. For example, different APs or AP pairs may have priority over other APs, such as when an AP is located in a client dense location. In other embodiments, the auto location system 110 can schedule the AP ranging sessions based on a queue system, such as APs 104 entering a queue when the APs 104 determine to perform ranging. The auto location system 110 may also schedule ranging sessions based on which sessions are less likely to cause interference. For example, the auto location system 110 may schedule AP pairs that can have preamble codes associated with low cross-correlation, have APs 104 that are further distances away from each other, and/or the like to minimize potential interference.

Additionally, the auto location system 110 can schedule AP ranging sessions based on how many sessions can be supported at a time, how many sessions UWB radios of the APs 104 can support, and/or the like. For example, each time period (e.g., T0, T1, etc.) may support a maximum of twelve AP ranging sessions, and the auto location system 110 will schedule the sessions according to the requirements. The auto location system 110 can also schedule AP ranging sessions based on the number of sessions UWB radios of APs and/or other devices may support at a time.

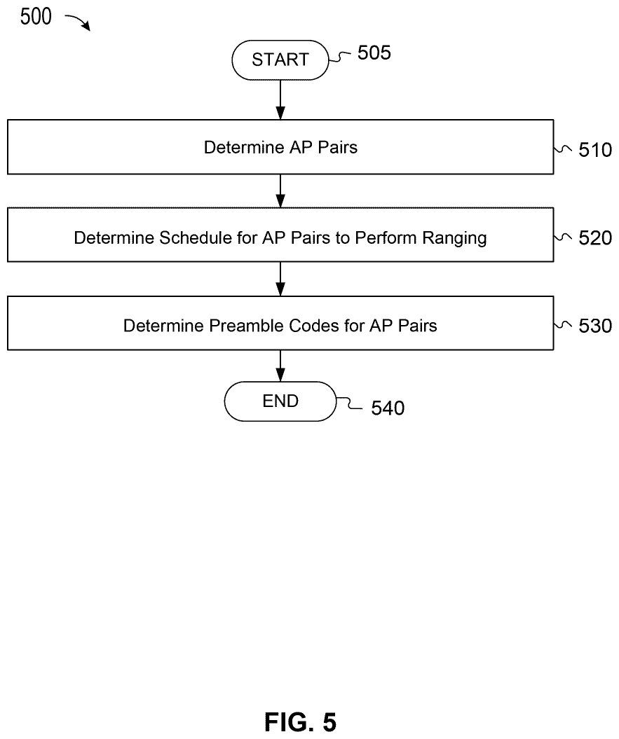

FIG. 5 is a flow chart of a method 500 for AP location techniques using UWB in accordance with aspects of the present disclosure. The method 500 may begin at starting block 505 and proceed to operation 510. In operation 510, a plurality of AP pairs are determined. For example, the auto location system 110 determines AP pairs of the APs 104 based on the positions of the APs. All neighbor APs may be paired for performing AP-to-AP ranging.

In operation 520, a schedule is determined for the plurality of AP pairs to perform AP-to-AP ranging. For example, the auto location system 110 determines a schedule for the AP pairs to perform AP-to-AP ranging. The schedule can be based on session priority, a queue system, locations of the AP pairs, which sessions are less likely to cause interference, how many sessions can be supported at a time, sessions UWB radios can support, and/or the like as described above with respect to FIG. 4.

In operation 530, preamble codes are determined for each AP pair. The AP pairs operate according to the preamble codes to manage cross-correlation between AP pairs of the plurality of AP pairs scheduled to perform AP-to-AP ranging simultaneously, wherein the plurality of AP pairs are operable to perform AP-to-AP ranging using UWB and according to the schedule and the preamble codes for each AP pair. For example, the auto location system 110 determines preamble codes for the AP pairs so the AP pairs have weak cross-correlation for ranging signals. The auto location system 110 can determine preamble codes according to the operations and methods described above. Determining the preamble codes can comprise determining a first preamble code for a first AP pair of the plurality of AP pairs (e.g., the first pair of APs 320) on a first floor 308 of a building 300, and determining a second preamble code for a second AP pair of the plurality of AP pairs (e.g., the second pair of APs 322) on a second floor 310 of the building 300, wherein the second AP pair is adjacent to the first AP pair and the first preamble code and the second preamble code have a cross-correlation below a threshold.

The method 500 can further include maximizing a function of path loss for the plurality of AP pairs, and attenuating signal strengths of the plurality of AP pairs during AP-to-AP ranging based on maximizing the function of path loss. For example, the auto location system 110 can instruct the APs to attenuate signal strengths according to the maximized path loss function. The method 500 can include determining frames between two AP pairs of the plurality of AP pairs collided and, in response, changing the preamble code of one AP pair of the two AP pairs. The APs 104 are operable to perform AP-to-AP ranging according to the schedule and preamble codes to determine AP locations and enable ranging orchestration for client tracking. The method 500 can conclude at ending block 540.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for AP location techniques using UWB with respect to FIG. 1, FIG. 2, FIG. 3, FIG. 4, and FIG. 5. Computing device 600, for example, may provide an operating environment for the APs 104, the client 106, the auto location system 110, and the like. The APs 104, the client 106, the auto location system 110, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

FIG. 7 illustrates an implementation of a communications device 700 that may implement one or more of the APs 104, the client 106, the auto location system 110, etc., of FIGS. 1-5. In various implementations, the communications device 700 may comprise a logic circuit. The logic circuit may include physical circuits to perform operations described for one or more of the APs 104, the client 106, the auto location system 110, etc., of FIGS. 1-5, for example. As shown in FIG. 7, the communications device 700 may include one or more of, but is not limited to, a radio interface 710, baseband circuitry 730, and/or the computing device 600.

The communications device 700 may implement some or all of the structures and/or operations for the APs 104, the client 106, the auto location system 110, etc., of FIGS. 1-5, storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHY processing circuit for the d link layer processing of respective receive/transmit signals. Baseband circuitry 730 may include, for example, a Media Access Control (MAC) processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a plurality of Access Point (AP) pairs;
determining a schedule for the plurality of AP pairs to perform AP-to-AP ranging; and
determining preamble codes for each AP pair to manage cross-correlation between AP pairs of the plurality of AP pairs scheduled to perform AP-to-AP ranging simultaneously, wherein the plurality of AP pairs are operable to perform AP-to-AP ranging using Ultra-Wideband (UWB) and according to the schedule and the preamble codes for each AP pair.

2. The method of claim 1, wherein APs of the plurality of AP pairs are operable to perform AP-to-AP ranging to determine AP locations and enable ranging orchestration for client tracking.

3. The method of claim 1, wherein determining the preamble codes comprises:
determining a first preamble code for a first AP pair of the plurality of AP pairs on a first floor of a building; and
determining a second preamble code for a second AP pair of the plurality of AP pairs on a second floor of the building,
wherein the second AP pair is adjacent to the first AP pair and the first preamble code and the second preamble code have a cross-correlation below a threshold.

4. The method of claim 1, further comprising:
maximizing a function of path loss for the plurality of AP pairs; and
attenuating signal strengths of the plurality of AP pairs during AP-to-AP ranging based on maximizing the function of path loss.

5. The method of claim 1, further comprising:
determining frames between two AP pairs of the plurality of AP pairs collided; and
in response, changing the preamble code of one AP pair of the two AP pairs.

6. The method of claim 1, wherein determining the schedule is based at least in part on any one of (i) a session priority, (ii) a queue system, or (iii) both (i) and (ii).

7. The method of claim 1, wherein determining the schedule is based at least in part on any one of (i) a number of supported AP-to-AP ranging sessions per interval, (ii) an number of supported UWB radio sessions, or (iii) both (i) and (ii).

8. A system comprising:
a memory storage; and
a processing unit coupled to the memory storage, wherein the processing unit is operative to:
determine a plurality of Access Point (AP) pairs;
determine a schedule for the plurality of AP pairs to perform AP-to-AP ranging; and
determine preamble codes for each AP pair to manage cross-correlation between AP pairs of the plurality of AP pairs scheduled to perform AP-to-AP ranging simultaneously, wherein the plurality of AP pairs are operable to perform AP-to-AP ranging using Ultra-Wideband (UWB) and according to the schedule and the preamble codes for each AP pair.

9. The system of claim 8, wherein APs of the plurality of AP pairs are operable to perform AP-to-AP ranging to determine AP locations and enable ranging orchestration for client tracking.

10. The system of claim 8, wherein determining the preamble codes comprises to:
determine a first preamble code for a first AP pair of the plurality of AP pairs on a first floor of a building; and
determine a second preamble code for a second AP pair of the plurality of AP pairs on a second floor of the building,
wherein the second AP pair is adjacent to the first AP pair and the first preamble code and the second preamble code have a cross-correlation below a threshold.

11. The system of claim 8, the processing unit being further operative to:
maximize a function of path loss for the plurality of AP pairs; and
attenuate signal strengths of the plurality of AP pairs during AP-to-AP ranging based on maximizing the function of path loss.

12. The system of claim 8, the processing unit being further operative to:
determine frames between two AP pairs of the plurality of AP pairs collided; and
in response, change the preamble code of one AP pair of the two AP pairs.

13. The system of claim 8, wherein to determine the schedule is based at least in part on any one of (i) a session priority, (ii) a queue system, or (iii) both (i) and (ii).

14. The system of claim 8, wherein to determine the schedule is based at least in part on any one of (i) a number of supported AP-to-AP ranging sessions per interval, (ii) an number of supported UWB radio sessions, or (iii) both (i) and (ii).

15. A non-transitory computer-readable medium that stores a set of instructions which when executed perform a method executed by the set of instructions comprising:
determining a plurality of Access Point (AP) pairs;
determining a schedule for the plurality of AP pairs to perform AP-to-AP ranging; and
determining preamble codes for each AP pair to manage cross-correlation between AP pairs of the plurality of AP pairs scheduled to perform AP-to-AP ranging simultaneously, wherein the plurality of AP pairs are operable to perform AP-to-AP ranging using Ultra-Wideband (UWB) and according to the schedule and the preamble codes for each AP pair.

16. The non-transitory computer-readable medium of claim 15, wherein APs of the plurality of AP pairs are operable to perform AP-to-AP ranging to determine AP locations and enable ranging orchestration for client tracking.

17. The non-transitory computer-readable medium of claim 15, wherein determining the preamble codes comprises:
determining a first preamble code for a first AP pair of the plurality of AP pairs on a first floor of a building; and
determining a second preamble code for a second AP pair of the plurality of AP pairs on a second floor of the building,
wherein the second AP pair is adjacent to the first AP pair and the first preamble code and the second preamble code have a cross-correlation below a threshold.

18. The non-transitory computer-readable medium of claim 15, the method executed by the set of instructions further comprising:
maximizing a function of path loss for the plurality of AP pairs; and
attenuating signal strengths of the plurality of AP pairs during AP-to-AP ranging based on maximizing the function of path loss.

19. The non-transitory computer-readable medium of claim 15, the method executed by the set of instructions further comprising:
determining frames between two AP pairs of the plurality of AP pairs collided; and
in response, changing the preamble code of one AP pair of the two AP pairs.

20. The non-transitory computer-readable medium of claim 15, wherein determining the schedule is based at least in part on any one of (i) a session priority, (ii) a queue system, or (iii) both (i) and (ii).
